(19) United States
(12) Patent Application Publication
(10) Pub. No.: US 2020/0013107 A1
(43) Pub. Date: Jan. 9, 2020

(54) RECOMMENDATION SYSTEM, METHOD, APPARATUS AND PROGRAM

(71) Applicant: NEC Corporation, Minato-ku, Tokyo (JP)

(72) Inventor: Hideyuki KUSANO, Tokyo (JP)

(73) Assignee: NEC Corporation, Minato-ku, Tokyo (JP)

(21) Appl. No.: 16/495,140

(22) PCT Filed: Mar. 29, 2018
(86) PCT No.: PCT/JP2018/013485

§ 371 Date: Sep. 18, 2019

(30) Foreign Application Priority Data
Mar. 30, 2017 (JP) 2017-069246

(51) Int. Cl. G06Q 30/06; G06N 5/04; G06F 17/50

(52) U.S. Cl. CPC G06Q 30/0631; G06F 17/5009; G06N 5/04

(57) ABSTRACT

The present invention enables recommendation of a network product suitably introduced to a system of a user. A simulation on performance of a system on which a network product not yet purchased by a user is assumed to be installed and/or performance of the network product is performed, and recommendation information is presented based on a result of the simulation.

### TECHNICAL FIELD

### Reference to Related Application

The present invention is based upon and claims the benefit of the priority of Japanese patent application No. 2017-069246, filed on Mar. 30, 2017, the disclosure of which is incorporated herein in its entirety by reference thereto.

The present invention relates to a recommendation system, method, apparatus and program.

### BACKGROUND

A cloud service which provides a user software, data, server functions, etc., via a network has been in widespread use. For example, a cloud service provider installs a server(s) in a data center or the like and allows their customers to use virtual servers, data storage areas, applications, etc., via a network. In addition, as network virtualization technologies, SDN (software-defined network)/NFV (network functions virtualization) technology has attracted attention. According to these technologies, a network appliance(s) or the like are realized as software on a virtual machine(s) (VM(s)) implemented on a virtualization layer such as a hypervisor provided on a server.

NFV is realized based on a MANO (Management & Orchestration) architecture, for example. With the NFV, network services can be aggregated as virtualized network services on a cloud (a data center) which can be operated as a cloud service. For example, practical use of a virtualized customer-premises equipment (vCPE) has been proposed (NPL 1). This vCPE is realized by implementing CPE which is a communication facility arranged at a tenant site, on a cloud as a virtual function. In this vCPE, network appliances such as a router, a switch, firewall (FW), NAT (network address translation), DHCP (dynamic host configuration protocol), etc. are implemented, for example, on a server of a carrier cloud, as virtualized network functions (VNFs) based on an ETSI (European Telecommunications Standards Institute) NFV framework. The vCPE may be configured by virtualizing functions of layer 3 (L3) or the like of the OSI (Open Systems Interconnection) reference model formulated by the International Organization for Standardization (ISO), for example. In this case, for example, CPE communication facilities of layer 2 (L2) may be installed on the site side.

A carrier cloud is a cloud service provided by a carrier (a telecommunications carrier) and provides, for example, cloud infrastructures such as a data center, a server(s), and an application(s) integrally with a network. FIGS. 1A and 1B schematically illustrate an example in which a communication facility 1A (CPE) at a site A is implemented as a virtualized network function on a server of a carrier cloud 3. A terminal apparatus A at the site A in FIG. 1A connects to an edge switch SW1 in a wide area network (WAN) 2 via the communication facility (CPE) 1A and communicatively connects to a terminal apparatus B at a site B via the WAN 2, though not limited thereto.

In the example illustrated in FIG. 1B, there is provided a vCPE in which a FW and a NAT, which are communication functions of the communication facility (CPE) 1A at the site A in FIG. 1A, are implemented as VNFs (vFW and vNAT) on a server of the carrier cloud 3. In FIG. 1B, a communication facility 1A′ at the site A includes a CPE of layer 2 (L2) and provides a function of tunneling (for example, an L2 VPN (Virtual Private Network)) to the carrier cloud 3. The vCPE 1C provides, for example, CPE functions of layer 3 (L3). By specifying tenants of the enterprise sites A and B and a service chain, a communication service provided by the corresponding path is specified. In the example in FIG. 1B, the service chain (VNF forwarding graph) is as follows.

Service edge apparatus 1A->vNAT->vFW-> . . . ->Service edge apparatus 1B

The carrier may provide an MPLS (Multi-Protocol Label Switching)-VPN (Virtual Private Network), a wide-area Ethernet (Ethernet is a registered trademark), an Internet VPN, or the like, as a WAN service. In addition, other than the above communication facility (CPE) at the sites, for example, the carrier cloud can provide a network service, such as a virtual Evolved Packet Core (vEPC), in which EPC, i.e., a core network for LTE (Long Term Evolution), is virtualized.

In addition, by controlling a plurality of VNF packet forwarding paths based on a service chaining technology, etc., the carrier cloud can provide tenants with various kinds of network service.

PTL 1 discloses, as a related technology of the virtual EPC, and discusses, a problem about a virtual node to be added or removed being different depending on a traffic type inputted to the system, in cases where a plurality of types of virtual node (for example, a PGW (packet data network gateway), an SGW (serving gateway), and an MME (mobility management entity)) are handled and a plurality of types of traffic (for example, traffic per message type of an individual call control signal and traffic per packet length of user data) are handled. PTL 1 discloses a configuration to solve this problem, the configuration including a communication amount measurement part that manages a communication amount per virtual machine and an addition and removal number determination part that determines the number of virtual machines to be added or removed. The communication amount measurement part acquires a communication amount for each of the types of the traffic processed by an individual one of the plurality of types of virtual node. The addition and removal number determination part determines, based on the communication amount per traffic type, the type of the virtual node which a virtual machine is added to or removed from and the number of virtual machines to be added or removed.

PTL 2 discloses a configuration that acquires a key performance indicator(s) (KPI) that defines an overall performance necessary for a VNF(s), acquires performance characteristics of an execution unit(s) of an available type(s), and obtains a possible deployment plan based on the acquired KPI(s) and performance characteristics.

PTL 3 discloses a configuration that controls allocation of traffic to a forwarding destination VNF depending on the carrier or user to which the traffic forwarded to the VNF belongs. The allocation of the traffic forwarded to the VNF is controlled based on a service level set for at least one of a carrier (for example, an MNO (mobile network operator) or an MVNO (mobile virtual network operator) carrier), the user, the content of the traffic, etc.

PTL 4 discloses a configuration in which a free resource amount of a physical server is acquired, and a resource mount associated with selected workload is compared with the free resource amount, and the selected workload is extracted when the resource amount is equal to or less than the free resource amount.

PTL 5 discloses a virtual server resource control system that calculates, based on anticipated increase amounts of a memory(ies) and a disk(s) per day, a date(s) on which thresholds for the corresponding memory utilization(s) and disk(s) of a physical server(s) are exceeded.

PTL 6 discloses a configuration that measures the maximum processing performances of a plurality of physical servers and determines resource amounts that satisfy requested amounts of the processing performances of a plurality of virtual servers, as processing of a second pass. This configuration enables to allocate to the virtual server a resource amount that satisfies the requested amount of the processing performance of the virtual server.

There are known a technology for recommending an applications and contents that a customer may like by using attribute information of the customer, history information of a user, or history information of users having a similar attribute(s). In a marketplace on the Internet, the recommendation is made, for example, based on information about a purchase history or an action history of a user. For example, PTL 7 describes a recommendation function.

### CITATION LIST

### Patent Literature

PTL 1: Japanese Patent Kokai Publication No. JP2015-149578A
PTL 2: Japanese Patent Kokai Publication No. JP2015-56182A
PTL 3: International Publication No. WO2016/148049A1
PTL 4: International Publication No. WO2011/093011A1
PTL 5 Japanese Patent Kokai Publication No. JP2014-225081A
PTL 6: International Publication No. WO2011/043011A1
PTL 7: Japanese Patent Kokai Publication No. JP2011-141892A

### Non Patent Literature

NPL 1: “virtualized Customer Premises Equipment vCPE” (searched on Mar. 3, 2017<Internet URL:http://jpn.nec.com/tcs/vcpe/index.html>

### SUMMARY

### Technical Problem

The following describes analysis of the related technologies.

Issues arising under a case wherein a customer (a user) can purchase a virtual service product (VNF) provided by, for example, a carrier (MNO) or a third party such as an MVNO on a marketplace, and a network function is implemented, by NFV or the like, on a carrier cloud, will hereinafter be described.

Even if a VNF product that a customer has not yet purchased is recommended on the marketplace or the like, a requested performance of the system, SLA (Service Level Agreement) on which the customer has made a contract, QoS (Quality Of Service) requirement of an application used by the customer, etc. may not always be satisfied.

The above related technologies only disclose proposing design change of a virtual server(s) already operating on a virtual system of the customer, based on information about the virtual server(s). Thus, optimization can be achieved only in a range of what has or have been purchased by the customer (user).

The present invention has been made in view of the above issues, and it is an object of the present invention to provide a system, a method, an apparatus, and a program, each enabling to recommend a network product that may be suitably introduced to a system of a user, for example.

### Solution to Problem

According to an aspect of the present invention, there is provided a recommendation system, including

a means that performs a simulation of performance, for example, of a system of a user, on which a network product not yet purchased by the user is assumed to be installed, and/or the network product, and presents recommendation information based on a result of the simulation.

According to another aspect of the present invention, there is provided a recommendation method for recommending a product(s) to a user, the method including:

performing a simulation of performance, for example, of a system of a user, on which a network product not yet purchased by the user is assumed to be installed, and/or the network product; and

presenting recommendation information based on a result of the simulation.

According to still another aspect of the present invention, there is provided a simulator (an apparatus), which performs a simulation of performance, for example, of a system of a user, on which a network product not yet purchased by the user is assumed to be installed, and/or the network product, and presents recommendation information based on a result of the simulation.

According to still another aspect of the present invention, there is provided a program, causing a computer to perform processing comprising:

performing a simulation of performance, for example, of a system of a user, on which a network product not yet purchased by the user is assumed to be installed, and/or the network product; and

presenting recommendation information based on a result of the simulation.

According to still another mode of the present invention, there is provided a computer-readable recording medium storing a program that causes a computer to perform processing comprising:

performing a simulation of performance, for example, of a system of a user, on which a network product not yet purchased by the user is assumed to be installed, and/or the network product, before the network product is purchased by the user; and

presenting recommendation information based on a result of the simulation. The recording medium is provided as a non-transitory computer-readable recording medium such as a semiconductor storage such as a random access memory (RAM), a read-only memory (ROM), or an electrically erasable and programmable ROM (EEPROM), a hard disk drive (HDD), a compact disc (CD), or a digital versatile disc (DVD).

### Advantageous Effects of Invention

According to the present invention, it is made possible to provide a system that can recommend a network product suitably introduced to a system of a user.

### BRIEF DESCRIPTION OF THE DRAWINGS

FIG. 1A is a diagram illustrating a related technology.

FIG. 1B is a diagram illustrating the related technology.

FIG. 2 is a diagram illustrating a first example embodiment of the present invention.

FIG. 3A is a diagram illustrating a second example embodiment of the present invention.

FIG. 3B is a diagram illustrating the second example embodiment of the present invention.

FIG. 4 is a diagram illustrating an example of the present invention.

FIG. 5 is a flowchart illustrating the example of the present invention.

FIG. 6 is a diagram illustrating an example of a GUI (graphical user interface) according to the example of the present invention.

FIG. 7 is a diagram illustrating a third example embodiment of the present invention.

FIG. 8 is a diagram illustrating a basic mode of the present invention.

### DESCRIPTION OF EMBODIMENTS

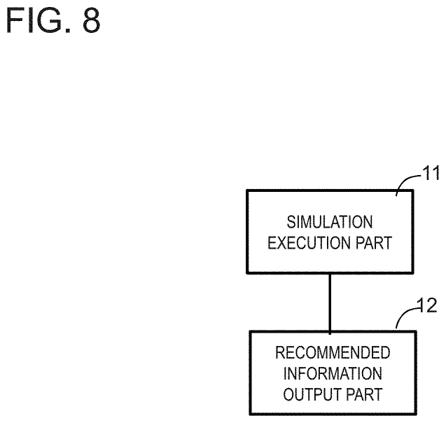

A basic aspect of the present invention will be described with reference to FIG. 8. As illustrated in FIG. 8, according to an aspect of the present invention, for example, a recommendation system (apparatus) includes: a simulation execution part 11 that performs a simulation on performance of a system (a system of a user (for example, an enterprise user or a customer)) in a case where a network product that the user has not yet installed on the system, is assumed to be installed on the system, and/or on performance of the network product, and a recommendation information output part 12 that presents recommendation information based on a result of the simulation. Configured in this way, the present invention can provide the recommend system that can recommend a product which may be suitably installed in the user's system of the user.

According to an aspect of the present invention, when the result of the simulation satisfies a predetermined requirement(s), the recommendation information output part 12 may present information on the network product, or the result of the simulation and information on the network product as the recommendation information.

According to an aspect of the present invention, when the result of the simulation does not satisfy the predetermined requirement(s), the recommendation information output part 12 may omit presenting the result of the simulation and the recommendation information about the product. Configured in this way, the recommendation information output part 12 can avoid providing the user with unnecessary recommendation information and related information (for example, the result of the simulation).

According to an aspect of the present invention, the recommendation information may be displayed and outputted to a user interface (UI). The recommendation information output part 12 may display and output the recommendation information on a display apparatus of a terminal, for example. The recommendation information output part 12 may display and output the recommendation information on a display apparatus of another node to which the recommendation information output part 12 communicatively connects via a communication network interface. Alternatively, the recommendation information output part 12 may output the recommendation information to a file apparatus to which the recommendation information output part 12 communicatively connects via an interface of a communication network such as a local area network (LAN) or a wide area network (WAN). The simulation execution part 11 and the recommendation information output part 12 may be configured as a pair in an identical apparatus or may be implemented in different nodes connected to each other via a communication network such as a LAN or a WAN, for example.

According to an aspect of the present invention, based on at least one of:

resource information;

failure information; and

traffic information

about a system including a network product already purchased by the user, the simulation execution part 11 may perform a simulation on cases where the user performs at least one of:
switching to an alternative network product;
addition of a new network product; and
increase or decrease in the number of the network products.

According to an aspect of the present invention, the network product may be a virtual service (one or more VNFs constituting a virtual service).

### Example Embodiment 1

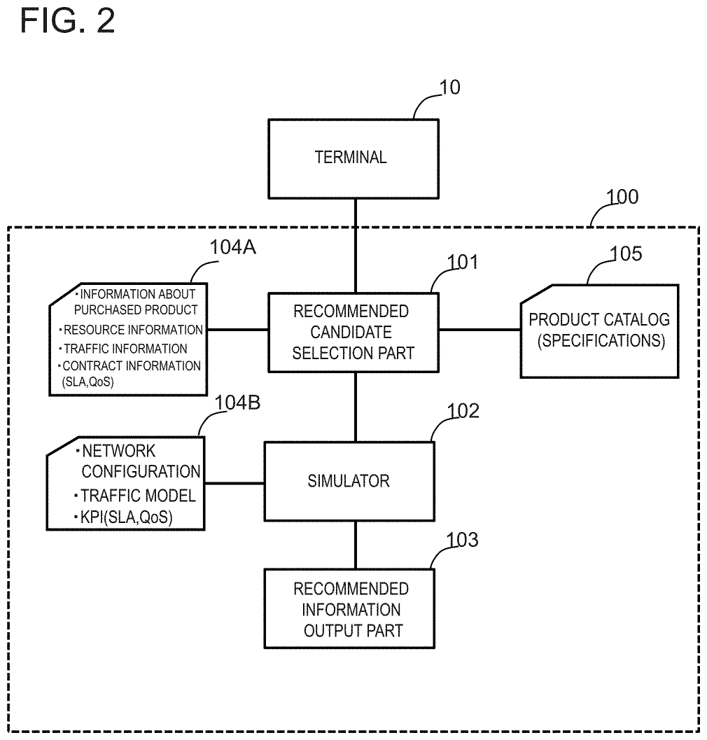

FIG. 2 schematically illustrates an example of a configuration according to a first example embodiment of the present invention. As illustrated in FIG. 2, a recommendation system 100 includes a recommended candidate selection part 101, a simulator 102, and a recommendation information output part 103.

Based on input information (for example, identification information about a customer account) from a terminal 10, the recommended candidate selection part 101 may refer to information registered and managed as customer information 104A on a per customer basis (for example,

information about a product(s) purchased by a customer,

resource information and traffic information about a network of a system, construction of which a customer is involved in, and

contract information (SLA, QoS requirements, etc.)) and select a product candidate(s) to be recommended (also referred to as a recommended candidate product(s)) from a product catalog 105 (a product library). The product catalog 105 may include specifications, price, vendor name, etc. of a network product that, for example, a carrier, etc. can provide to a customer. While not particularly limited, for example, the product catalog 105 may store, as product specifications, the following information:

functions of a product;

size;

throughput and band, such as the number of packets that can be processed per unit time by the product,

required CPU (Central Processing Unit) performance and memory capacity, etc.

For example, based on traffic information of a system of a customer registered and managed as the customer information 104A per customer, and by analyzing a network load or the like in the system of the customer, the recommended candidate selection part 101 may extract a network appliance such as a load balancer as a candidate product to be recommended to the customer.

Alternatively, the recommended candidate selection part 101 may extract, as a recommended candidate product, a product relating to a product that a customer wishes to purchase from the terminal 10 (for example, a product that belongs to an identical category, has high-performance, has a different price range). The recommended candidate selection part 101 may hand over product information about the recommended product (network product) included in the product catalog 105 to the simulator 102. While not particularly limited, examples of the product information that the recommended candidate selection part 101 hands over to the simulator 102 includes

function of the product,

throughput and band, such as the number of packets that can be processed per unit time by the product, and

required CPU performance and memory capacity, etc.

By referring to the network configuration registered and managed as customer information 104B per customer (for example, information about an individual node that constitutes the network, information about a link connecting nodes, etc.) and based on, for example,

topology information in which the recommended candidate product selected by the recommended candidate selection part 101 is deployed on the network,

process model of an individual node on the network, and

traffic model information registered and managed as the customer information 104B per customer,

the simulator 102 may perform a simulation on the network in which the recommended candidate product is deployed.

The traffic model of a network of a customer (user) may include the following information:

data frequency;

data amount;

delay characteristics;

band, etc.

These items of information may be extracted from statistical information, etc., about traffics on a network currently used by the customer. The simulator 102 may calculate a delay, etc., based on throughput of the product (for example, the number of data items processed per unit time), a generated traffic amount (size), traffic (data) occurrence intervals (frequency), and a traffic model such as a traffic pattern or tendency.

While not particularly limited, the simulator 102 may perform a simulation, for example, based on input information such as

a network topology in which the recommended candidate product is deployed,

specifications (function, performance) of an individual network product,

a traffic model, and

KPI (for example, at least one of packet loss rate, delay characteristics, CPU load (CPU utilization), memory load (memory utilization), etc. which are SLA evaluation items).

The recommendation information output part 103 may recommend the recommended candidate product to the user when the result of the simulation performed by the simulator 102 satisfies a delay time SLA, a QoS requirement, etc. on which the user has a contract.

When presenting a product that the customer (user) has not purchased as a recommended product, based on the result of the simulation, the recommendation information output part 103 may present the result of the simulation (for example, a KPI value, etc.) obtained by the simulator 102.

According to another embodiment, in addition to a product that a customer (user) has not purchased, for example, the recommended candidate selection part 101 may select a product that the customer has already purchased and causes the simulator 102 to analyze throughput, performance, etc. of the product. Based on a result of the simulation on the product that the customer has already purchased, the recommendation information output part 103 may proposes scale-up, scale-in, migration of the product that the customer has already purchased, replacing with a product with a more advanced function in the same category, or the like, and output this proposal as recommendation information.

As will be described in the following second example embodiment, the above recommended product may be one or more VNFs that realize one or more virtual network service functions. Alternatively, the above recommended product may be a part or an entirety of a virtualized network service function such as the virtualized CPE function or virtualized EPC described above.

### Example Embodiment 2

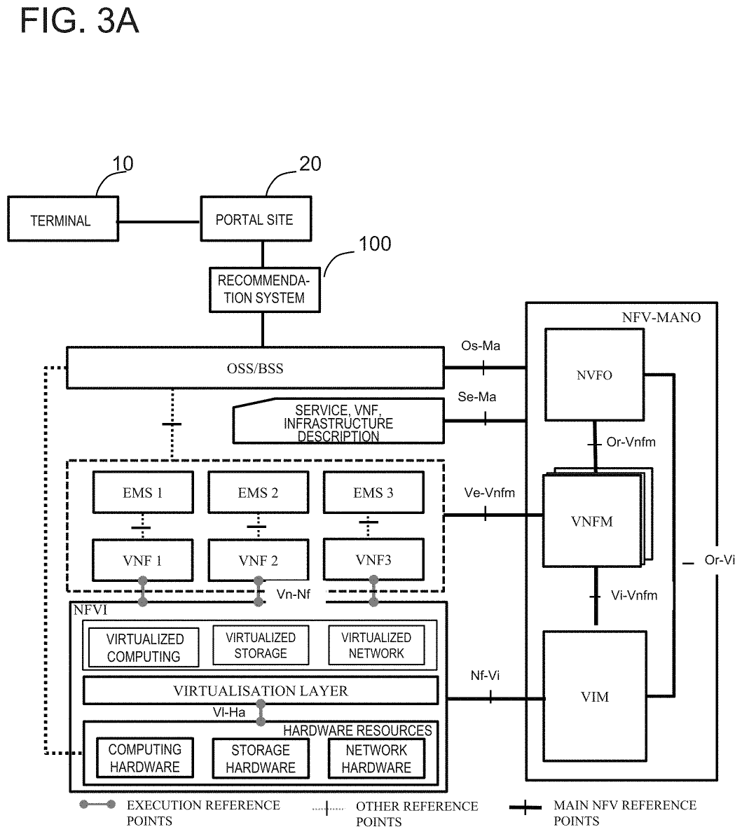

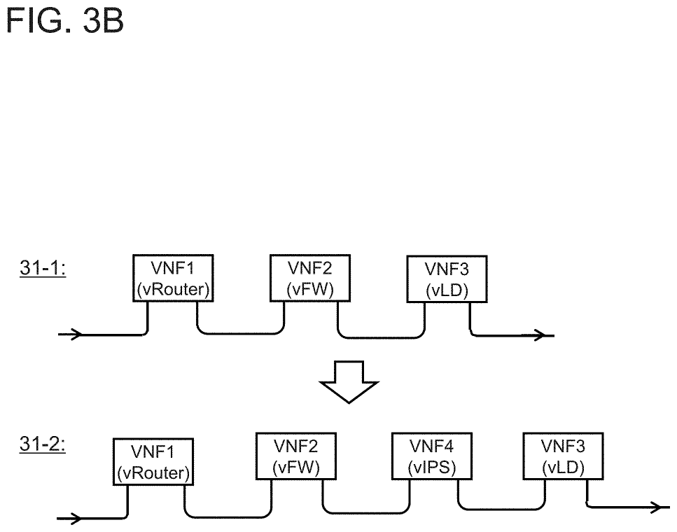

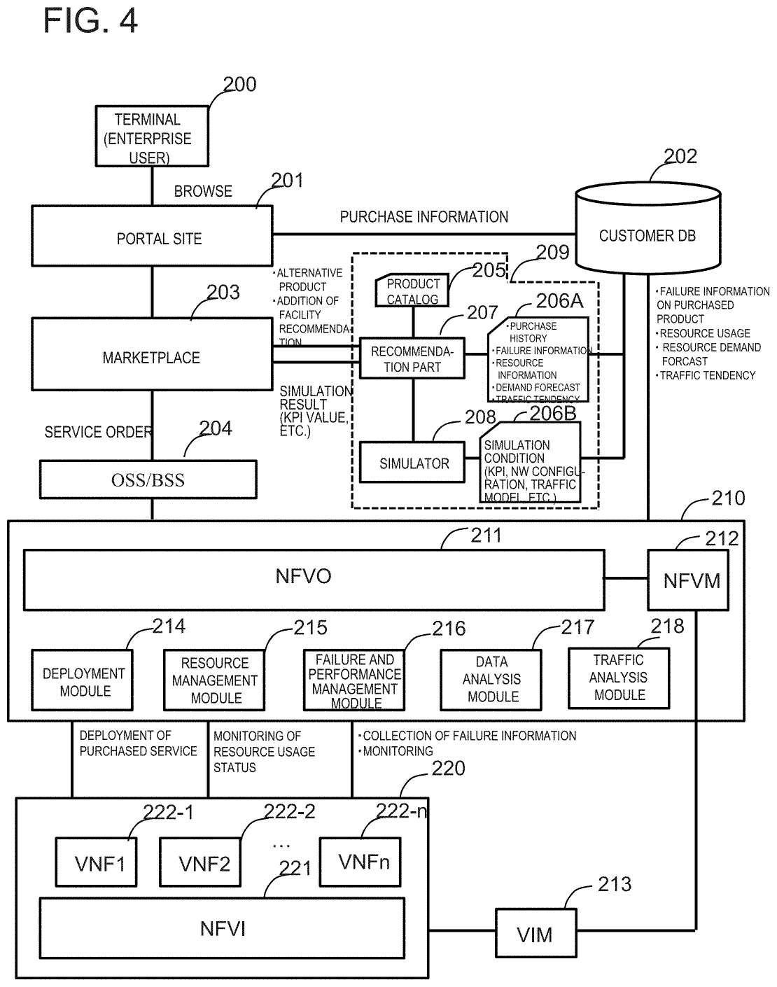

FIGS. 3A and 3B illustrate a second example embodiment of the present invention. FIG. 3A illustrates an example in which a virtual service (VNF) is used as a recommended product based on FIG. 2. In addition, FIG. 3A is based on FIG. 4 in chapter 7 in ETSI GS NFV 002 V1.1.1 (2013-10).

In FIG. 3A, an NFVI (network function virtualization infrastructure) constituting a virtualization Infrastructure for VNFs is an infrastructure in which hardware resources of a physical machine (a server) such as computing, storage, and network function are virtualized in a virtualized layer such as a hypervisor or a container and are flexibly used as virtualized computing, virtualized storage, and virtualized network.

NFV (network function virtualization)-MANO (management and orchestration) provides a function of managing hardware resources, software resources, and VNFs and a function of performing orchestration.

An NFV orchestrator (network function virtualization orchestrator: NFVO) manages the NFVI and VNFs and performs orchestration, to realize a network service(s) on the NFVI (for example, allocation of resources to VNFs and management of VNFs (auto-healing, auto-scaling, lifecycle management of VNFs, etc.)).

A VNF manager (virtual network function manager: VNFM) performs lifecycle management of VNFs (for example, instantiation, update, query, healing, scaling, termination, etc.) and event notification.

A VIM (virtualized infrastructure manager) controls the NFVI (management of computing, storage, and network resources, monitoring of failure of the NFVI which is an NFV execution infrastructure, monitoring of resource information, performance measurement, event collection and forwarding, etc.) and generates virtual resources based on instructions from the NFVO and the VNFM. For example, in the implementation of the NFV based on the ETSI (European Telecommunications Standards Institute), OpenStack is used.

In addition, a management function referred to as EMS (Element Management System) is arranged per VNF (for example, for monitoring a failure per VNF). While FIG. 3A illustrates an example in which three VNFs 1 to 3 and three EMS s 1 to 3 are arranged, the number of VNFs and the number of EMSs are not of course limited to 3.

“Service, VNF, infrastructure description” includes a VNF descriptor (VNFD), a VNF forwarding graph descriptor (VNFFGD), a virtual link descriptor, a physical network function descriptor (PNFD), etc., which are not illustrated.

An OSS (operations support systems) outside the NVF framework is a general term for a system (equipment, software, a mechanism, etc.) needed by, for example, a telecommunications carrier (carrier) to construct and operate a service(s). A BSS (business support systems) is a general term for an information system (equipment, software, a mechanism, etc.) used by, for example, a telecommunications carrier (carrier) for billing and charging for usage and the like, customer care, etc. Description of reference points will be omitted.

In FIG. 3A, VNF1 to VNF3 are VNFs constituting service chains already provided to a user. In FIG. 3A, the terminal 10 accesses the recommendation system 100 via, for example, a portal site 20. When the terminal 10 requests the NFV-MANO to deploy a VNF via, for example, the OSS/BSS, a new VNF is deployed on the NFVI under control of the NFVO, NFVM, and VIM.

The recommended candidate selection part 101 (FIG. 2) in the recommendation system 100 selects a recommended candidate product(s) (a VNF product(s) that has(have) not been purchased by the user), for example, in relation to a VNF product(s) that has(have) been purchased by the user.

The recommended candidate selection part 101 may select a recommended candidate product(s), for example, based on network statistical information (traffic information, resource information, and failure information) collected by the NFV-MANO.

In the recommendation system 100 in FIG. 3A, information such as specifications of VNFs in a product catalog not illustrated (105 in FIG. 2) may be based on, for example, information about a VNF library prepared by the NFV-MANO or the VNF descriptor (VNFD) managed by the NFVO (NFV orchestrator).

It is assumed that the VNF 1 to VNF 3 in FIG. 3A are, for example, a virtualized router (vRouter), a virtualized firewall (vFW), and a virtualized load balancer (vLD), as illustrated in FIG. 3B. A reference numeral 31-2 in FIG. 3B indicates an example in which the recommendation system 100 has additionally deployed a vIPS (virtualized IPS) on a service chain 31-1 in FIG. 3B, as a recommended product, wherein the vIPS is a virtualized function of an intrusion prevention system (IPS). The vIPS in the service chain 31-2 in FIG. 3B is generated, for example, as a VNF 4 (not illustrated) in FIG. 3A.

For example, if the recommendation system 100 in FIG. 3A selects the vIPS (VNF 4) in FIG. 3B as a recommended candidate product, for example, based on a tendency of a traffic of the user (for example, based on a relationship between traffic data outputted from an enterprise site to an external network and traffic data flowing from the external network to the enterprise site). In this case, the simulator (102 in FIG. 2) in the recommendation system 100 may calculate a delay or the like based on the following information:

a throughput of an individual VNF product (the number of transactions(processes) per unit time, etc.); and

an amount (size) of traffic that is generated by the customer (enterprise user) or that flows into the customer (enterprise user), generation intervals (frequency), or a traffic model such as a pattern. As a result of the simulation performed by the simulator 102, for example, if a delay time SLA or a QoS requirement of an application on which the user has made a contract, the recommendation information output part (103 in FIG. 2) in the recommendation system 100 recommends the vIPS to the terminal 10.

While FIG. 3A illustrates a configuration example in which the recommendation system 100 is connected to the OSS/BSS, the configuration of the present example embodiment is not, as a matter of course limited, to this configuration example. For example, the recommendation system 100 may be implemented on the OSS/BSS. Alternatively, for example, the recommendation system 100 may be implemented on a server that realizes the NFV-MANO or the like, as a recommendation engine or the like.

It is noted that FIG. 3A illustrates an example in which the recommendation system 100 is connected to a system in which a VNF purchased by a user is actually deployed on the NFVI. In the example in FIG. 3A, the recommendation system 100 directly communicatively connects to the OSS/BSS, etc. This is to collect, for example, performance information (traffic information) such as an actual throughput of a service chain currently provided to the user before simulating a performance of a VNF as a recommended candidate product. However, if the recommendation system 100 can receive, for example, performance information about an actual throughput of the service chain, in some way, the recommendation system 100 does not need to communicatively connect directly to the OSS/BSS, the NFV-MANO, etc.

### Example

FIG. 4 illustrates an example according to the second example embodiment described with reference to FIG. 3. FIG. 4 schematically illustrates a configuration in which the second example embodiment is applied to a system that performs maintenance and operation of virtual services. In FIG. 4, a portal site 201 is a customer portal site for managing products purchased by individual customers (enterprise users) and for performing purchasing by individual customers (enterprise users) on a marketplace 203. From the terminal 200 of the customer (enterprise user), the customer (enterprise user) logs in and accesses the marketplace 203.

The marketplace 203 presents a product catalog (prices, specifications, vendor names, etc.) of virtual services provided by, for example, a carrier(s) (an MNO(s), etc.) or a virtual services provided by a third party(ies) (for example, virtual services provided by an MVNO(s), etc. that provide communication service(s) by renting communication facilities from a carrier(s)). The marketplace 203 may be a common marketplace that handles products of different types of business (companies), other than the virtual service products provided by the carrier(s) (MNO(s)) and MVNOs. In addition, as the specifications of the products available on the marketplace 203, for example, the specifications of a single VNF or one or more VNFs constituting a virtual service function may be presented.

A recommendation function based on the above described simulation may present a recommended product that a customer has not yet purchased or present a simulation result, etc., on a display screen of the marketplace 203.

In an NFVO (NFV orchestrator) 211 in an NFV-MANO 210, a deployment module 214 receives a service order from a customer via an OSS/BSS 204, deconstructs the service order, and deploys a VNF 222 that realizes a virtual service on an NFVI 221 in a server 220. One or a plurality of VNFs may be used to realize the virtual service.

A resource management module 215 collects resource usage of the product(s) (the VNF(s)) that has already been purchased by the customer (example: resource usage rate of a CPU, a memory or the like, link usage rate of a network of a customer, etc.).

A failure and performance management module 216 monitors a virtual service product(s) (VNF(s)) already purchased by the customer and collects failure information (example: alarm). The failure and performance management module 216 may collect failure information about a VNF reported to an NFVM 212 from an EMS (not illustrated) which is arranged per VNF.

A data analysis module 217 calculates resource forecast and traffic tendency of a customer network.

A traffic analysis module 218 monitors traffic of a customer network and analyzes a type or flow of the traffic.

For example, a customer database (DB) 202 stores the following information per customer (enterprise user):

a purchase history of virtual services, and

those collected and calculated by the NFVO 211, including:

failure information about a purchased product(s) (VNF(s)),

resource utilization;

resource demand forecast;

traffic tendency, and so forth.

The recommendation module 209 may be made to correspond to the recommendation system 100 in FIG. 3A. The recommendation module 209 includes a recommendation part 207 and a simulator 208. The recommendation part 207 may be considered as a part that includes, for example, the recommended candidate selection part 101 and the recommendation information output part 103 in FIG. 2. The simulator 208 may be considered as an element that corresponds to the simulator 102 in FIG. 2.

A product catalog 205 may be made to correspond to the product catalog 105 in FIG. 2. The product catalog 205 may include specifications, prices, vendor names, etc. of VNF products constituting virtual services (network services). For example, the product catalog 205 may include, as the specifications of the VNF products, information extracted from, for example, setting information in a VNF descriptor (VNFD) in which requirements, constraint conditions, etc. of VNFs are prescribed. Examples of the information include

functions of a VNF, and

requirements, constraints, etc. of various kinds of resources such as a virtual CPU set and a virtual memory used by a VNF(s).

The recommendation part 207 can select a recommended candidate product to the customer (enterprise user) from the product catalog 205 based on at least one of the following information: failure information, purchase history, resource information, anticipated demand forecast, traffic tendency, and simulation result (input information 206A) stored in the customer database 202 per customer (enterprise user). The input information 206A may be made to correspond to the customer information 104A in FIG. 2.

For example, when there is a product (VNF) whose resource usage status is excessively high, the recommendation part 207 may select addition of this kind of product (VNF) as a recommended candidate.

Alternatively, based on failure information about a service product (VNF) already purchased by the customer (enterprise user) and, for example, depending on a degree of failure, the recommendation part 207 may select switching to an alternative product (VNF) in the same category as a recommended candidate.

When the recommended candidate is addition of a product or switching of a product, the simulator 208 may simulate how much a performance index (a KPI value) (for example, call loss rate, packet loss rate, CPU load, etc.) which is a scale indicating an effect achieved by installing the product, will be improved.

The simulator 208 receives a simulation condition and a recommended candidate product set by the recommendation part 207 and performs a simulation.

While not particularly limited, as input information 206B of the simulation condition supplied to the simulator 208, for example, a part or entirety of the following information may be supplied to the simulator 208:

a virtual machine(s) (a VM(s)) on a customer network;

a VNF configuration, a network topology;

a traffic model; and

the number of subscribers (the number of subscribers of a communication service(s) provided by the customer).

The input information 206B may be made to correspond to the customer information 104B in FIG. 2.

The recommendation module 209 may refer to a result of the simulation obtained by the simulator 208, and determine a recommended candidate product as a recommended product, when the recommended candidate product satisfies, for example, a predetermined condition relating to a KPI value (for example, if a KPI value will be improved).

The recommendation module 209 may display the result of the simulation on a display screen of the terminal 200 via the marketplace 203.

Regarding the recommended product, other than a virtual service product that has not been purchased by the customer (enterprise user), the recommendation module 209 may present, as recommendation information, improvement in delay characteristics due to scale-up or scale-in (inclusive of scale-down or scale-out) of the product (VNF) or migration to a different site (a data center at a different location, for example), based on the result of the simulation.

The recommendation module 209 may present, on a screen presented to a customer (a corporate, a user) via the marketplace 203, for example.

a plurality of recommended products, side by side or

information about a recommended product(s) and information about a product(s) already purchased by the customer (the enterprise user), side by side.

By providing the above presentation modes, the customer (enterprise user) can compare, for example, a plurality of recommended products and select one of the recommended products. Alternatively, the customer (enterprise user) can compare an already purchased product with a recommended product and select whether to purchase the recommended product.

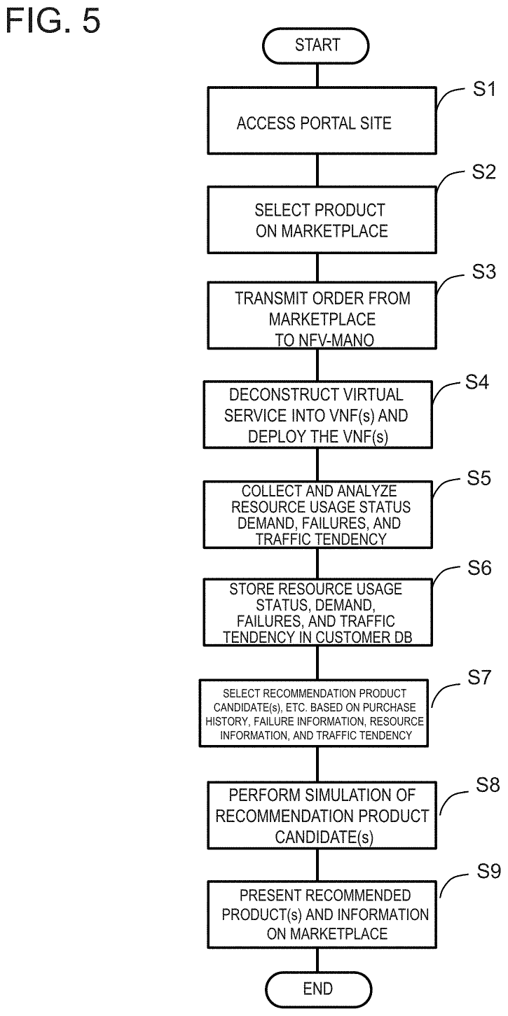

FIG. 5 is a flowchart illustrating a series of processing for recommending a vendor product (VNF) to a user on the marketplace based on a use status or failure information of an already purchased virtual service in the system in FIG. 4. The vendor may be a 3rd party vendor (in this case, VNFs, EMSs, VNFMs and so forth may be those of the third party).

### <Step S1>

The customer (enterprise user) who wishes to purchase a virtual service(s) opens the portal site 201 from the terminal 200 (corresponding to 10 in FIG. 2, FIG. 3A) (corresponding to “browse” in the portal site 201 in FIG. 4).

### <Step S2>

The customer (enterprise user) logs in the marketplace 203 that handles virtual services from the terminal 200 to select and purchase a target product(s).

### <Step S3>

The marketplace 203 transmits an order (service order) of the product(s) to be purchased by the customer (enterprise user) to the NFVO (NFV orchestrator) 211 of the NFV-MANO 210, for example, via the OSS/BSS 204.

### <Step S4>

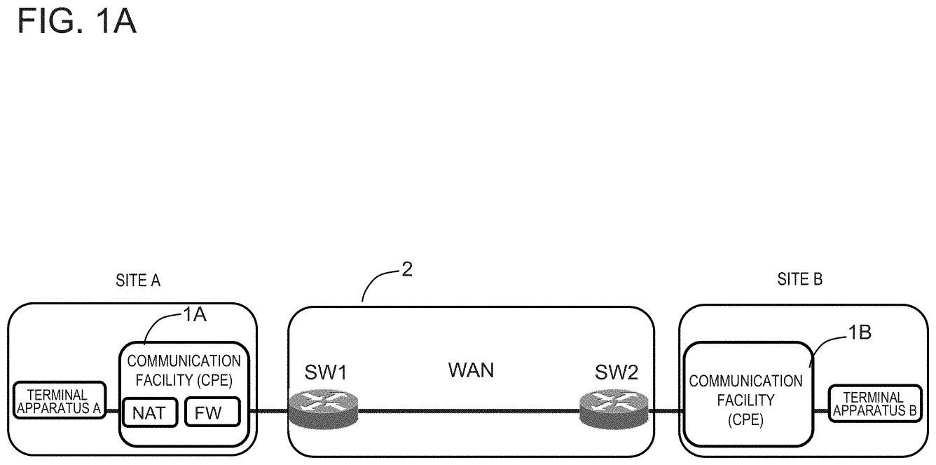

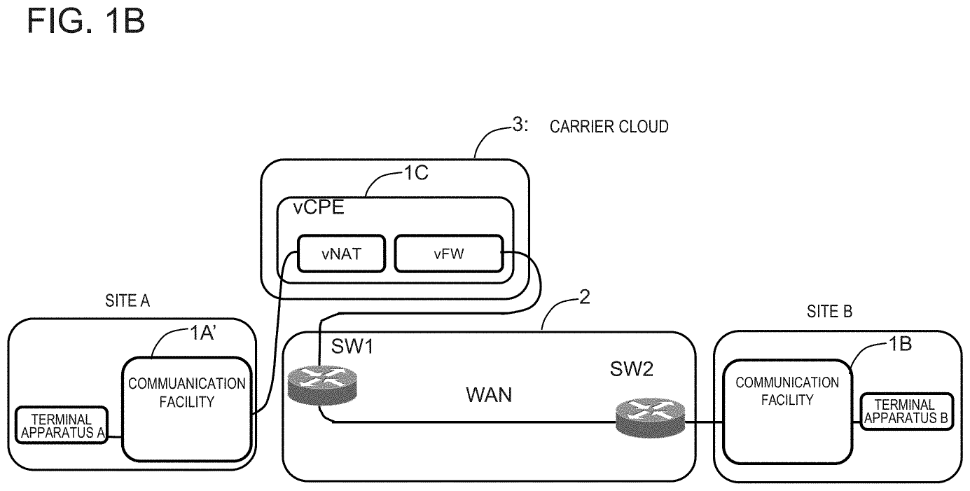

The NFVO 211 deconstructs the service order (virtual service function), for example, into VNFs and deploys the VNFs on the NFVI 221 under control of the NFVM 212 and the VIM 213, though not limited thereto. For example, when the ordered virtual service function is a virtualized communication facility (vCPE) 1C described with reference to FIG. 1B, the virtual service function is divided into VNFs serving as a virtual firewall (vFW) and a virtual NAT. VNF(s) constituting a virtual service function may be presented as an explanation of the virtual service function which is a product(s) provided on the marketplace 203. The NFVO 211 may deconstruct the service order into VDUs (virtual deployment units) or VNFCs (VNF Components).

### <Step S5>

Based on a processing result of at least one of the resource management module 215, the failure and performance management module 216, the data analysis module 217, and the traffic analysis module 218, the NFVO 211 monitors a product(s) (VNF(s)) purchased by the customer (enterprise user) and collects at least one of resource usage status, failure information, resource demand forecast, and traffic tendency.

### <Step S6>

The resource usage status, product failure information, resource demand forecast, and traffic tendency collected by the NFVO 211 are transmitted to and stored in the customer database (DB) 202 which is configured to manage the customer information per customer (enterprise user).

### <Step S7>

The recommendation module 209 receives one or all of the history of virtual service products purchased by the customer (enterprise user), the failure information about the purchased products, the resource usage statuses, the resource demand forecast, and the traffic tendency from the customer database (DB) 202. The recommendation module 209 selects a recommended candidate product(s) for the customer (enterprise user) on the marketplace 203 based on the input information.

### <Step S8>

Next, the simulator 208 in the recommendation module 209 simulates a performance of a system in which the recommended candidate product is installed. For example, the simulator 208 simulates how much the KPI values such as a throughput, delay characteristics, and a call loss rate, an operation status, and a resource consumption amount will be improved when a VNF selected as a product candidate (for example, a product that has not been purchased by the enterprise user) is deployed on a network of the customer (enterprise user). Alternatively, the simulator 208 may simulate how much the KPI values will be improved due to scale-out, scale-up, or the like of the VNF, for example, based on a resource usage status and a traffic model such as a network load.

### <Step S9>

For example, if improvement in the performance of the recommended candidate product or the KPI(s) is confirmed as a result of the simulation, the recommendation module 209 recommends this candidate product to the terminal 200 of the customer (enterprise user) via the marketplace 203. In this step, the result of the simulation may be presented on the terminal 200.

The recommendation module 209 may recommend switching of a product that may result in a product failure or the like to a different product, based on the failure information about the products (VNFs) currently installed. In this case, the simulator 208 simulates the different product as the recommended candidate product and recommends the different product if a desired performance is satisfied.

The recommendation module 209 may select a product candidate to be recommended, based on the traffic monitoring result and the traffic tendency. For example, when traffic concentration to a specific location of a network node of the enterprise user, the recommendation module 209 may select a load balancer (virtualized load balancer) for load balancing as a recommended product candidate. In this case, the simulator 208 simulates a throughput, delay and forth, when the product candidate is deployed in the network of the enterprise user.

As described above, in the system in FIG. 4, for example, when switching from a currently installed product (VNF) to a different product is recommended, a throughput and a delay characteristic after the switching may be simulated, and the result of the simulation may be presented. The simulator 208 simulates not only the product already purchased by the enterprise user but also the case in which a product not purchased is installed and calculates a result. In this way, further optimization of the operating status of the virtual system of the customer (enterprise user) can be achieved.

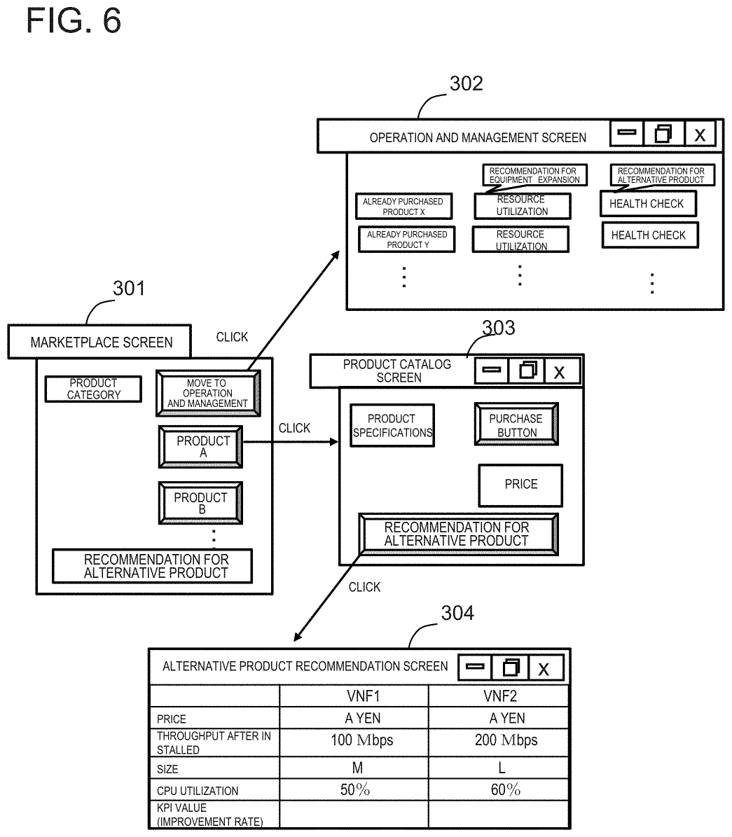

FIG. 6 illustrates an example of a graphical user interface displayed on the terminal 200 that has accessed the marketplace 203 in FIG. 4. It is noted that FIG. 6 schematically illustrates screen transition and images of individual screen configurations (minimum). FIG. 6 schematically illustrates examples of screens only for description purposes, and therefore, elements, configurations, and layouts of the screens are not, as a matter of course, limited to those illustrated in FIG. 6.

When a “button for moving to operation and management screen” displayed on a marketplace screen 301 in FIG. 6, is clicked on the terminal 200, a transition to an operation and management screen 302 is made (the operation and management screen 302 is displayed as a pop-up window). The recommendation information about an alternative product (already simulated) selected based on the history information about a product(s) purchased by the customer (enterprise user) acquired, for example, from the customer (enterprise user) account identification information (ID) may be presented on the marketplace screen 301.

On the operation and management screen 302, for example, the results of “purchased product”, “resource utilization”, and “health check” in the network system of the customer (enterprise user) are displayed. If necessary, information about recommendation for equipment-expansion, information about recommendation for an alternative product, etc. is displayed. As the recommendation for equipment expansion or the recommendation for an alternative product, a plurality of items of recommendation information may be presented side by side (a plurality of items of information regarding equipment expansion, a plurality of items of information regarding an alternative product). Alternatively, information about a recommended product(s) and information about a product(s) already purchased by the customer (enterprise user) may be presented side by side. Instead of displaying the information about recommendation for equipment expansion or the information about an alternative product along with the resource utilization, etc. on the same screen, the user may be allowed to click a button for “recommendation for equipment expansion” or a button for “recommendation for an alternative product”. In this way, detailed information about “recommendation for equipment expansion” or “recommendation for an alternative product” may be presented on a pop-up screen. The recommendation information about equipment expansion, an alternative product, or the like may be displayed on a screen along with information that supports the recommendation (for example, the KPI improvement rate or load information included in the result of the simulation).

When a button “product A” displayed on the marketplace screen 301 in FIG. 6 is clicked on the terminal 200, a transition to a product (merchandise) catalog screen 303 (the product catalog screen 303 is displayed as a pop-up screen) is made.

On the product catalog screen 303, for example, the product specifications, the price, a purchase button (“Add to Cart” or the like), and recommendation for an alternative product are displayed. When the product A is a VNF product, an alternative product is a VNF product which has been selected by the recommendation module 209 in FIG. 4 and on which the simulator 208 has performed a simulation. The recommendation information about the product may be displayed on a screen along with, for example, information supporting the recommendation (for example, the KPI improvement rate or the load information included in the result of the simulation).

Information about the recommended product and information which provides a basis for the recommendation (examples: KPI improvement rate, load information, etc.) may be displayed within the product catalog screen 303 or a different screen after switching from the product catalog screen 303. For example, when the user moves the cursor to the product name, the above information may be displayed on a pop-up screen. For example, when the user clicks the button for “recommendation for an alternative product” on the product catalog screen 303, an alternative product recommendation screen 304 may be pop-up displayed.

In the alternative product recommendation screen 304, a plurality of alternative products may be displayed side by side. While not particularly limited thereto, the example of the alternative product recommendation screen 304 represents, regarding two VNFs (VNF 1 and VNF 2), which are alternative products, prices, throughputs (unit: Mbps (Mega bits per second)) when the VNFs are installed on the system, VNF sizes (scales) (for example, small: S, middle: M, large: L, etc.), the CPU utilizations, and the KPI values (the packet loss rates, delay characteristics, etc.) are presented. However, as the network functions become more complex, the VNF scale and size are also increased. Specifically, there are examples in which a plurality of virtual machines (VMs) coordinate with each other to realize a single VNF. Thus, for example, when a single VNF is implemented on a single VM and when less resources such as for a virtual CPU set and a virtual memory necessary for the VM are used, an S size may be used. When a single VNF is implemented on a single VM and when more resources such as for the necessary virtual CPU set and virtual memory are used, an M size may be used. When a single VNF needs coordination on a plurality of VMs, an L size may be used. Alternatively, the VNF size may be quantified, instead of being classified into categories.

On the alternative product recommendation screen 304, when information about a plurality of alternative products is presented, for example, information about a product(s) that is more inexpensive than the other alternative product(s) while the KPI such as packet loss rate or delay characteristics is somewhat less than the other alternative product(s) (or product(s) undergoing scale-out or scale-down) may also be presented as a reference example(s) of a recommended product(s). This is because the customer (enterprise user) could replace a current product by an inexpensive product as long as a predetermined network characteristic(s) is (are) satisfied.

On the alternative product recommendation screen 304, the VNF 1 may be a product that is presented as a recommended product, and the VNF 2 may be a product that is presented as a product already purchased by the customer (enterprise user). As illustrated on the alternative product recommendation screen 304, for example, since information about a plurality of recommended products is presented side by side, the customer (enterprise user) can select one of the products by comparing the items of information. In addition, when items of information about an alternative product, a product already purchased by the customer (enterprise user), and a recommended product are presented side by side on the alternative product recommendation screen 304, the customer (enterprise user) can select one of the products by comparing items of information. In this case, information about a product(s) whose price (purchase price, rental fee, or the like) is more inexpensive than the product already purchased by the customer (enterprise user) (or information about product(s) undergoing scale-out or scale-down) may also be presented as a reference example(s) of the recommended product(s). This is because the customer (enterprise user) could replace a current product by a more inexpensive alternative product as long as a desired network characteristic(s) is(are) satisfied through the installation of the more inexpensive alternative product.

While not particularly limited, the terminal 200 of the customer (enterprise user) may select an index (example: SLA, QoS) for a plurality of recommended products displayed on a screen (for example, 304) displaying recommendation information about alternative products and sort and display a plurality of recommended products based on the selected index. In this operation, instead of displaying all the sorted recommended products, a several number of the recommended products higher in rank may be presented along with the index.

### Example Embodiment 3

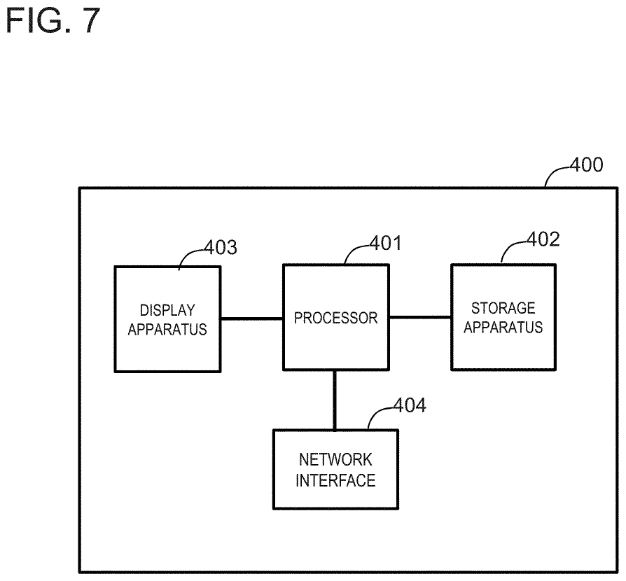

As illustrated in FIG. 7, the recommendation system 100 may be implemented on a computer apparatus 400. As illustrated in FIG. 7, the computer apparatus 400 includes a processor (a CPU (central processing unit), a data processing apparatus) 401, a storage apparatus 402 including at least one of a semiconductor memory (for example, a random access memory (RAM), a read-only memory (ROM), an electrically erasable and programmable ROM (EEPROM), etc.), a hard disk drive (HDD), a compact disc (CD), a digital versatile disc (DVD), etc., a display apparatus 403, and a network interface (network interface card: NIC) 404. The network interface 404 communicatively connects to the terminal 10. A program that realizes functions of the recommendation apparatus described in the example embodiments is stored in the storage apparatus 402. By reading and executing the program stored in the storage apparatus 402, the processor 401 is configured to realize the functions of the recommendation system according to the example embodiments.

The disclosure of each of the above PTLs 1 to 7 and NPL 1 is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in the claims, examples, drawings, etc.) are possible within the scope of claims of the present invention. Namely, the present invention of course includes various variations and modifications that could be made by those skilled in the art according to the overall disclosure including the claims and the technical concept.

For example, the above example embodiments may be noted as follows (but not limited thereto).

### (Supplementary Note 1)

A recommendation system, performing a simulation on performance of a system on which a network product(s) not yet purchased by a user is(are) assumed to be installed and/or performance of the network product(s) and presenting recommendation information based on a result of the simulation.

### (Supplementary Note 2)

The recommendation system according to note 1, wherein, when the result of the simulation satisfies a predetermined requirement(s), information about the network product(s) or the result of the simulation and information about the network product(s) is outputted as the recommendation information.

### (Supplementary Note 3)

The recommendation system according to note 1 or 2, including means for displaying and outputting the recommendation information to a user interface.

### (Supplementary Note 4)

The recommendation system according to any one of notes 1 to 3, wherein the simulation is performed based on network configuration information, traffic information, or a performance requirement(s) about the system on which the network product(s) not yet purchased by the user is(are) assumed to be installed.

### (Supplementary Note 5)

The recommendation system according to any one of notes 1 to 4, wherein, based on at least one of resource information, failure information, and traffic information about the system including a network product(s) already purchased by the user, the simulation is performed on cases where the user performs at least one of: switching to an alternative product(s), addition of a new product(s), and expansion or reduction of the network product(s) already purchased by the user.

### (Supplementary Note 6)

The recommendation system according to note 3, wherein the product(s) is(are) displayed as a product(s) exhibited on a marketplace screen accessed by a terminal of the user, and the recommendation information is displayed on a corresponding product screen on the marketplace screen.

### (Supplementary Note 7)

The recommendation system according to any one of notes 1 to 6,

wherein the network product(s) includes a VNF(s) (a Virtualized Network Function(s)), and

wherein the recommendation system includes a simulator that acquires resource information, failure information, traffic information about a network system including a VNF product(s) already purchased by the user from an NFV (Network Functions Virtualization)-MANO (Management and Orchestration), performs a simulation based on configuration information, traffic information, or a performance requirement(s) about the network on which a VNF product(s) is(are) assumed to be installed before the VNF product(s) is(are) purchased by the user, and derives a predetermined performance index(es).

### (Supplementary Note 8)

A simulator wherein the simulator is configured to perform a simulation on performance of a system on which a network product(s) not yet purchased by a user is(are) assumed to be installed and/or performance of the network product(s) and output a simulation result.

### (Supplementary Note 9)

The simulator according to note 8, wherein the simulation is performed based on network configuration information, traffic information, or a performance requirement(s) about the system on which the network product(s) not yet purchased by the user is(are) assumed to be installed.

### (Supplementary Note 10)

The simulator according to note 8 or 9, wherein the network product(s) includes a VNF(s) (a Virtualized Network Function(s)), and wherein the simulation is performed based on configuration information, traffic information, or a performance requirement(s) about the network on which a VNF product(s) is(are) assumed to be installed before the VNF product(s) is(are) purchased by the user, and a predetermined performance index(es) is derived.

### (Supplementary Note 11)

A recommendation method for recommending a network product(s) to a user, the method including:

performing a simulation on performance of a system on which a network product(s) not yet purchased by the user is(are) assumed to be installed and/or performance of the network product(s), and

presenting recommendation information based on a result of the simulation.

### (Supplementary Note 12)

The recommendation method according to note 11, wherein, when the result of the simulation satisfies a predetermined requirement(s), information about the network product(s) or the result of the simulation and information about the network product(s) is outputted as the recommendation information.

### (Supplementary Note 13)

The recommendation method according to note 11 or 12, including displaying and outputting the recommendation information to a user interface.

### (Supplementary Note 14)

The recommendation method according to any one of notes 11 to 13, wherein the simulation is performed based on network configuration information, traffic information, or a performance requirement(s) about the system on which the network product(s) not yet purchased by the user is(are) assumed to be installed.

### (Supplementary Note 15)

The recommendation method according to any one of notes 11 to 14, wherein, based on at least one of resource information, failure information, and traffic information about the system including a network product(s) already purchased by the user, the simulation is performed on cases where the user performs at least one of: switching to an alternative product(s), addition of a new product(s), and expansion or reduction of the network product(s) already purchased by the user.

### (Supplementary Note 16)

The recommendation method according to note 13, wherein the network product(s) is(are) displayed as a product(s) exhibited on a marketplace screen accessed by a terminal of the user, and the recommendation information is displayed on a corresponding product screen on the marketplace screen.

### (Supplementary Note 17)

The recommendation method according to any one of notes 11 to 16, wherein the network product(s) includes a VNF(s) (a Virtualized Network Function(s)), and

wherein the recommendation method includes acquiring resource information, failure information, traffic information about a network system including a VNF product(s) already purchased by the user from an NFV (Network Functions Virtualization)-MANO (Management and Orchestration), performing a simulation based on configuration information, traffic information, or a performance requirement(s) about the network on which a VNF product(s) is(are) assumed to be installed before the VNF product(s) is(are) purchased by the user, and deriving a predetermined performance index(es).

### (Supplementary Note 18)

A program (and a recording medium in which the program is stored), causing a computer to perform processing for performing a simulation on performance of a system on which a network product(s) not yet purchased by a user is(are) assumed to be installed and/or performance of the network product(s) and

presenting recommendation information based on a result of the simulation.

### (Supplementary Note 19)

The program (and the recording medium) according to note 18, causing the computer to perform processing for outputting, when the result of the simulation satisfies a predetermined requirement(s), information about the network product(s) or the result of the simulation and information about the network product(s) as the recommendation information.

### (Supplementary Note 20)

The program (and the recording medium) according to note 18 or 19, causing the computer to perform processing for displaying and outputting the recommendation information to a user interface.

### (Supplementary Note 21)

The program (and the recording medium) according to any one of notes 18 to 20, causing the computer to perform processing for performing the simulation based on network configuration information, traffic information, or a performance requirement(s) about the system on which the network product(s) not yet purchased by the user is(are) assumed to be installed.

### (Supplementary Note 22)

The program (and the recording medium) according to any one of notes 18 to 21, causing the computer to perform processing for performing, based on at least one of resource information, failure information, and traffic information about the system including a network product(s) already purchased by the user, the simulation on cases where the user performs at least one of: switching to an alternative product(s), addition of a new product(s), and expansion or reduction of the network product(s) already purchased by the user.

### (Supplementary Note 23)

The program (and the recording medium) according to any one of notes 18 to 22, wherein the network product(s) includes a VNF(s) (a Virtualized Network Function(s)), and

wherein the program (and the recording medium) causes the computer to perform processing for acquiring resource information, failure information, traffic information about a network system including a VNF product(s) already purchased by the user from an NFV (Network Functions Virtualization)-MANO (Management and Orchestration), performing a simulation based on configuration information, traffic information, or a performance requirement(s) about the network on which a VNF product(s) is(are) assumed to be installed before the VNF product(s) is(are) purchased by the user, and deriving a predetermined performance index(es).

### REFERENCE SIGNS LIST

1A, 1A′, 1B communication facility
1C virtualized communication facility (vCPE)
2 wide area network (WAN)
3 carrier cloud (cloud service of telecommunications carrier)
10 terminal
11 simulation execution part
12 recommendation information output part
20 portal site (Web portal)
31-1, 31-2 service chain
100 recommendation system
101 recommended candidate selection part
102 simulator
103 recommendation information output part
104A, 104B customer information
105 product catalog
200 terminal (enterprise user terminal)
201 portal site
202 customer database (DB)
203 marketplace
204 OSS/BSS
205 product catalog
206A, 206B input information
207 recommendation part
208 simulator
209 recommendation module
210 NFV-MANO
211 NFVO
212 NFVM
213 VIM
214 deployment module
215 resource management module
216 failure and performance management module
217 data analysis module
218 traffic analysis module
220 server
221 NFVI
222-1 to 222-n VNF1 to VNFn
301 marketplace screen
302 operation and management screen
303 product catalog screen
304 alternative product recommendation screen
400 computer apparatus
401 processor
402 storage apparatus
403 display apparatus
404 network interface

What is claimed is:

1. A recommendation apparatus, comprising:
a processor; and
a memory storing program instructions executable by the processor, wherein the processor is configured to perform a simulation on performance of a system on which a network product not yet purchased by a user is assumed to be installed and/or the network product, and
present recommendation information based on a result of the simulation.

2. The recommendation apparatus according to claim 1, wherein, when the result of the simulation satisfies a predetermined requirement, the processor outputs information about the network product or the result of the simulation and information on the network product as the recommendation information.

3. The recommendation system apparatus according to claim 1, wherein the processor displays and outputs the recommendation information to a user interface.

4. The recommendation apparatus according to claim 1, wherein the processor performs the simulation based on network configuration information, traffic information, or a performance requirement about the system on which the network product not yet purchased by the user is assumed to be installed.

5. The recommendation apparatus according to claim 1, wherein, based on at least one of resource information, failure information, and traffic information about the system including a network product already purchased by the user,
the processor performs the simulation on at least one of cases including:
switching to an alternative product;
addition of a new product; and
increase or decrease of the number of the network products already purchased by the user.

6. The recommendation apparatus according to claim 3, wherein the processor displays the network product as a product exhibited on a marketplace screen accessed by a terminal of the user and displays the recommendation information on a corresponding product screen on the marketplace screen.

7. The recommendation apparatus according to claim 1, wherein the network product includes a VNF (Virtualized Network Function); and
wherein the processor executes a simulator that is configured to acquire, from an NFV (Network Functions Virtualization)-MANO (Management and Orchestration), resource information, failure information, traffic information about a network system including a VNF product already purchased by the user, perform a simulation based on configuration information, the traffic information, or a performance requirement about the network system on which a VNF product purchased by the user is installed, and derive a predetermined performance index.

8. (canceled)

9. A recommendation method for recommending a product to a user, the method comprising:
performing simulation on a system on which a network product not yet purchased by a user is assumed to be installed and/or performance of the network product; and
presenting recommendation information based on a result of the simulation.

10. A non-transitory computer-readable medium storing a program causing a computer to execute processing comprising:
performing simulation on a system on which a network product not yet purchased by a user is assumed to be installed and/or performance of the network product; and
presenting recommendation information based on a result of the simulation.

11. The recommendation method according to claim 9, comprising:
performing the simulation based on network configuration information, traffic information, or a performance requirement about the system on which the network product not yet purchased by the user is assumed to be installed.

12. The recommendation method according to claim 9, comprising:
based on at least one of resource information, failure information, and traffic information about the system including a network product already purchased by the user, performs the simulation on at least one of cases including:
switching to an alternative product;
addition of a new product; and
increase or decrease of the number of the network products already purchased by the user.

13. The recommendation method according to claim 9, comprising:
displaying the network product as a product exhibited on a marketplace screen accessed by a terminal of the user and displaying the recommendation information on a corresponding product screen on the marketplace screen.

14. The recommendation method according to claim 9, wherein the network product includes a VNF (Virtualized Network Function); and
wherein a simulator that acquires, from an NFV (Network Functions Virtualization)-MANO (Management and Orchestration), resource information, failure information, traffic information about a network system including a VNF product already purchased by the user, performs a simulation based on configuration information, the traffic information, or a performance requirement about the network system on which a VNF product purchased by the user is installed, and derives a predetermined performance index.

15. The non-transitory computer-readable medium according to claim 10, wherein the program causes the computer to execute processing comprising:
performing the simulation based on network configuration information, traffic information, or a performance requirement about the system on which the network product not yet purchased by the user is assumed to be installed.

16. The non-transitory computer-readable medium according to claim 10, wherein the program causes the computer to execute processing comprising:
based on at least one of resource information, failure information, and traffic information about the system including a network product already purchased by the user, performs the simulation on at least one of cases including:
switching to an alternative product;
addition of a new product; and
increase or decrease of the number of the network products already purchased by the user.

17. The non-transitory computer-readable medium according to claim 10, wherein the program causes the computer to execute processing comprising:
displaying the network product as a product exhibited on a marketplace screen accessed by a terminal of the user and displaying the recommendation information on a corresponding product screen on the marketplace screen.

18. The non-transitory computer-readable medium according to claim 10, wherein the network product includes a VNF (Virtualized Network Function), wherein the program causes the computer to execute processing comprising:
executing a simulator that acquires, from an NFV (Network Functions Virtualization)-MANO (Management and Orchestration), resource information, failure information, traffic information about a network system including a VNF product already purchased by the user, performs a simulation based on configuration information, the traffic information, or a performance requirement about the network system on which a VNF product purchased by the user is installed, and derives a predetermined performance index.
